(19) United States
(12) Patent Application Publication
(10) Pub. No.: US 2014/0059925 A1
(43) Pub. Date: Mar. 6, 2014

(54) EASY ACCESS SHED AND GREENHOUSE WITH SIDE DOORS

(71) Applicant: William C. Marsh, Palo Cedro, CA (US)

(72) Inventor: William C. Marsh, Palo Cedro, CA (US)

(21) Appl. No.: 13/596,804

(22) Filed: Aug. 28, 2012

(51) Int. Cl. E04H 1/12; A01G 9/14; E06B 1/52; E04B 1/344

(52) U.S. Cl. 47/17; 52/71; 52/204.1; 52/79.1

(57) ABSTRACT

An easy access shed structure that can be used as greenhouse. The shed structure having a frame assembly, two end doors, and two side doors. All doors of the shed are capable of being in an open position at the same time to allow full access to the contents in the interior of the shed. The invention also includes modular units that can be used separately or in combination as shed storage structures.

### INCORPORATION BY REFERENCE

All publications and patent applications mentioned in this specification are herein incorporated by reference to the same extent as if each individual publication or patent application was specifically and individually indicated to be incorporated by reference.

### FIELD

Embodiments of the present invention generally relate to shed or greenhouse structures that provide easy access to the enclosed space and contents housed within the structures.

### BACKGROUND

A variety of sheds, storage structures, and greenhouses exist for storing tools, equipment, vehicles, plants, or any other items. Typically, such storage structures provide either one or, at most, two main doors for accessing the contents stored in the structure. In some commercially available storage sheds, a single door along one wall allows ingress/egress. Other sheds provide double front doors for a larger entrance space to facilitate moving large items in and out of the storage shed. Still other sheds or storage structures include a rear door to provide two modes of access to the stored articles.

A major challenge with using such storage structures has been the limited access to items that are not stored near a door. To fully utilize available storage capacity, items are often stored along, on side walls, or in the middle of the storage structure away from a door. Often a storage structure contains items stored by a door and other articles stored behind or around those items. In order to gain access to an item behind another item or an item near a side wall, other items may need to be removed to provide an access path between the door and the desired item.

This is a time and effort consuming process that discourages users from taking out hard-to-reach items, which defeats the purpose of having the storage shed. Over time, users may chose not to retrieve hard-to-reach items or worse, users may forget they have that particular item and then purchase a duplicate item. As such, there is a need for a storage structure that allows full and easy access to the contents of the storage structure.

The embodiments of the invention have other features and advantages which will be apparent from or are set forth in more detail in the accompanying drawings, which are incorporated in and form a part of this specification, and the following Detailed Description of the Invention, which together serve to explain the principles of the invention.

### SUMMARY OF THE DISCLOSURE

Various aspects of the invention relate to an easy access shed structure having a frame assembly. The frame assembly may include a lower bottom frame defining a floor of the shed structure, the lower bottom frame connected to a front end frame along a perimeter, wherein the front end frame defines a front end of the shed structure; a rear end frame connected to another perimeter of the lower bottom frame, wherein the rear end frame defines a rear end of the shed structure; and a ridge component positioned on a top portion of the shed structure, the ridge component connected to the front end and rear end frames.

In other embodiments, the shed structure may also include a front door attached to the front end frame. The front door may cooperate with the front end frame and lower bottom frame to provide a front wall. A rear door can be attached to the rear end frame and cooperate with the rear end frame and lower bottom frame to provide a rear wall. Additionally, a first side door can be attached to the ridge component. The first side door can provide a side wall of the shed structure. A second side door can be attached to the ridge component where the second side door provides a side wall of the shed structure. The side doors may be configured to move outward from a longitudinal axis of the ridge component to expose an enclosed space within the frame assembly.

In some variations, the shed structure may include an end frames with an arcuate or bowed shape. The shed may also include side doors, the front door, and the rear door that can all be in an open position at the same time to expose an enclosed space within the frame assembly.

In various embodiments, the shed structure may include an attachment element configured to moveably attach the first and second side doors to the ridge component. The attachments element may be a piano hinge. In other embodiments, the first and second side doors have a locking mechanism connected to the side doors to retain the side doors in an open orientation. The locking mechanism may be a gas spring.

In further variations, the shed includes weather stripping. The weather stripping can be placed at points of connection between a door and the frame assembly to provide a seal against moisture, dust, insects and the like.

In further variations, the shed includes material allowing the transmission of light and infrared radiation into the enclosed space of the shed structure. In some cases, the doors or walls of the shed structure may be constructed from a translucent heat retaining material. The shed may also serve as a greenhouse.

In other embodiments, the shed has a foldable door. In further embodiments, the side doors of the shed pivot relative to the ridge component. In further variations, the side doors have a gull-wing shape.

In an alternative embodiment, the easy access shed structure has a frame assembly having a lower bottom frame defining a floor of the shed structure, the lower bottom frame connected to a front end frame along a perimeter, wherein the front end frame defines a front end of the shed structure; a rear end frame connected to another perimeter of the lower bottom frame, wherein the rear end frame defines a rear end of the shed structure; a ridge component positioned on a top portion of the shed structure, the ridge component connected to the front end and rear end frames; and a longitudinal member intersecting a vertical member of the front end frame and a vertical member of the rear end frame; a front door attached to the front end frame and cooperable with the front end frame and lower bottom frame to provide a front wall; a rear door attached to the rear end frame and cooperable with the rear end frame and lower bottom frame to provide a rear wall; a side door attached to the ridge component, the side door providing a side wall of the shed structure; and an uncovered section of the shed structure defined by a portion of the front, rear, and lower bottom frames and the ridge component, wherein the longitudinal member traverses the uncovered section by intersecting the vertical members of the end frames.

In further embodiments, the shed structure may have a plurality of modular units having a frame assembly having a lower bottom frame defining a floor of the shed structure, the lower bottom frame connected to a front end frame along a perimeter, wherein the front end frame defines a front end of the shed structure; a rear end frame connected to another perimeter of the lower bottom frame, wherein the rear end frame defines a rear end of the shed structure; a ridge component positioned on a top portion of the shed structure, the ridge component connected to the front end and rear end frames; and a longitudinal member intersecting a vertical member of the front end frame and a vertical member of the rear end frame; a front door attached to the front end frame and cooperable with the front end frame and lower bottom frame to provide a front wall; a rear door attached to the rear end frame and cooperable with the rear end frame and lower bottom frame to provide a rear wall; a side door attached to the ridge component, the side door providing a side of the shed with a side wall door; and an uncovered second side opposite the side wall door; wherein each modular unit is configured to be joined to another modular unit at the second side.

In any of the preceding embodiments, the shed structure may include a plurality of doors attached to an end frame.

In any of the preceding embodiments, the shed structure may include a material capable of retaining thermal energy within the enclosed space of the shed structure.

In any of the preceding embodiments, the floor of the shed structure may be open.

In any of the preceding embodiments, the floor of the shed structure may include at least one panel separating the enclosed space from ground.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a perspective view of a shed structure according to embodiments described.

FIG. 2 is a side view of a front end frame with a bottom frame for the shed structure in FIG. 1.

FIG. 3 is a side view of a rear end frame with a bottom frame for the shed structure in FIG. 1.

FIG. 4 is a side view of a shed structure with gull-wing side doors according to embodiments described.

FIG. 5 is a side view of a shed structure with double front doors.

FIG. 6 is a perspective view of an alternative shed structure.

FIG. 7 is a side view of two modular shed structure units.

FIG. 8 is a side view of a shed structure with foldable end doors.

### DETAILED DESCRIPTION

Reference will now be made in detail to exemplary embodiments of the invention, examples of which are illustrated in the accompanying drawings. While the invention will be described in conjunction with the exemplary embodiments, it will be understood that they are not intended to limit the invention to those embodiments. On the contrary, the invention is intended to cover alternatives, modifications and equivalents, which may be included within the spirit and scope of the invention as defined by the appended claims.

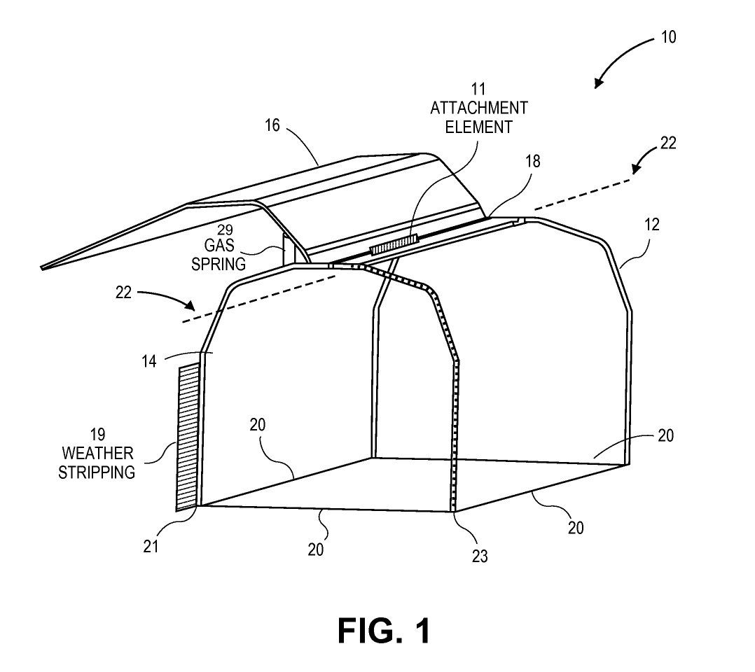

Various aspects of the inventions are directed to a shed or storage structure that provides easy access to the contents within the structure. As shown in FIG. 1, some embodiments provide for a shed structure having a frame assembly 10. In some embodiments, the frame assembly 10 includes frame components such as a front end frame 14, a rear end frame 12, and a lower frame 20 along the bottom of the shed structure. The frame components may be connected to one another through removable, detachable or permanent connections. For example, in some variations, a gusset member (not shown) may be placed at the intersection of frame components. Frame intersection points 21 and 23 may include a welded gusset member connecting the front end frame 14 to bottom frame 20. Alternatively, frame intersection points 21 and 23 may include a detachable interface whereby the front end frame 14 and the bottom frame 20 are attached by mating connectors that can be detached to disassemble the shed structure.

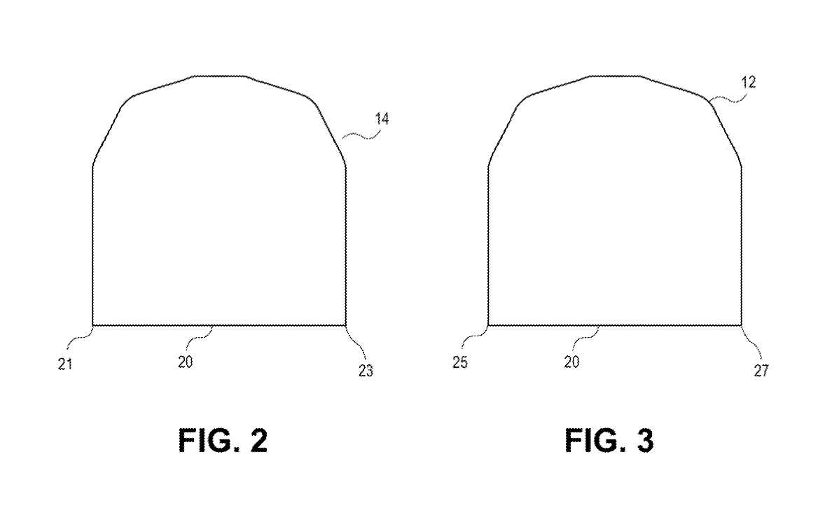

As shown in FIGS. 1 and 2, the front end frame 14 connects to a lower frame 20 along a perimeter of the lower frame 20. Intersection points 21 and 23 provide connection points between the two frame components. In some embodiments, the front end frame 14 connects to the lower frame 20 along a distance of the perimeter of the lower frame 20. Alternatively, the front end frame 14 connects to the lower frame at an intersection point or points along a perimeter of the lower frame 20. As can be appreciated, depending on the desired shed structure design, greater or fewer connections may be made between the frame components. For example, for a shed structure that can be disassembled, it may be desired to have a minimum number of connections needed to provide an upright secure but detachable frame assembly.

Additionally, the shed structure may have a rear end frame component 12 that is connected to the lower frame 20. FIG. 1 shows a rear end frame 12 that is connected to lower frame 20 along a perimeter of lower frame component 20. As with the front end frame 14, the connection between any of the frame components can be secured by a permanent or detachable connector such as a gusset member. FIG. 3 shows in one embodiment the connection points between the rear end frame 12 and lower bottom frame 20 are at intersection points 25 and 27 along the perimeter of the lower frame 20.

In some embodiments, the frame assembly 10 includes a ridge component 18 at a top portion of the frame assembly 10. The ridge component 18 may be any shape or design. As shown in FIG. 1, the ridge component is a generally rectangular strip intersecting a top portion of the front end frame 14 and the rear end frame 12. In some embodiments, the ridge component 18 is load-bearing. In other embodiments, the ridge component 18 maintains a distance between the front end frame 14 and rear end frame 12. The ridge component may also include an attachment element for attaching a door to the frame assembly 10. Additionally, the ridge component 18 has a longitudinal axis 22. The ridge component 18 may be secured in any suitable manner to the frame components. In some embodiments, pins (not shown) attach the ridge component 18 to the rear end and front end frames. As shown in FIGS. 1-3, the frame assembly has a rectangular base defined by the lower frame 20 and arcuate/bowed shaped front end 14 and rear end 12 frames. The shape of the shed structure is not limited to the ones disclosed and any alternative shapes can be employed. For example, instead of an arcuate shaped roof, the shed structure may have a gable style roof with an angular contour or a flat rectangular top. Additionally, the base can be any suitable shape.

In some embodiments, the bottom of the shed structure may be open or uncovered ground. In such cases, the bottom frame may rest directly on ground. Alternatively, the floor of the shed may include a covering from, for example, paneling or plywood. In other embodiments, the bottom of the shed may include a base raised from the ground. The base may include a platform, pallet, foundation, or structure that raises the floor of the shed above the ground.

Any suitable material may be used to construct the frame assembly 10. For example, in some embodiments, the frame assembly 10 can be constructed from plastic or metal tubing or piping such as PVC tubes, steel tubes, aluminum, flattened tubing, etc. Alternatively, the frame assembly 10 may be constructed from wood or a combination of materials as desired. In some embodiments, the frame assembly 10 may be constructed from metal beams or strips. Various methods of connecting the frame components of frame assembly 20 may be employed such as welding the components together at intersecting points or releasably connecting mated pair connectors between components.

Similarly, any suitable material may be used to construct the walls or base of the shed structure. Wall panels such as corrugated plastic may be used to cover the front, rear, or sides of the shed structure. Any materials such as plastics, glass, metal, etc. may be used for the shed panels to form walls, doors, or a roof. In some embodiments, the panels are made from a translucent material to allow light to reach the interior of the shed structure. In other embodiments, the panels are made from a heat retaining material that provides a greenhouse effect within the interior of the shed structure. For example, polycarbonate panels may be used to trap infrared or thermal energy inside the shed structure. In other embodiments, the panel material transmits light and infrared radiation into the interior of the shed structure. In further embodiments, a variety of panels can be used with a single shed structure. The panels may also be removed and replaced with other panels of different materials to provide, for example, a wall that can alternate from a translucent to an opaque material. The panels may be changed depending on the desired effect in different weather or seasons. The panels may be attached to the frame assembly 10 by any means such as pins, nails, slots, or any other retaining element(s).

In further embodiments, a front end of the shed structure is defined by the front end frame 14 and a portion of the lower frame 20, a rear end is defined by the rear end frame 12 and a portion of the lower frame 20, and two sides of the shed structure are between the front end and rear end frames on either side of the ridge component 18. As shown in FIG. 1, one of the sides of the shed includes a side door 16 that cooperates with the frame assembly 10 to allow closing and opening of the side door 16 against the frame assembly 10. In some embodiments, only one side of the shed structure includes a side door whereas the other side of the structure is a closed wall or open/uncovered side.

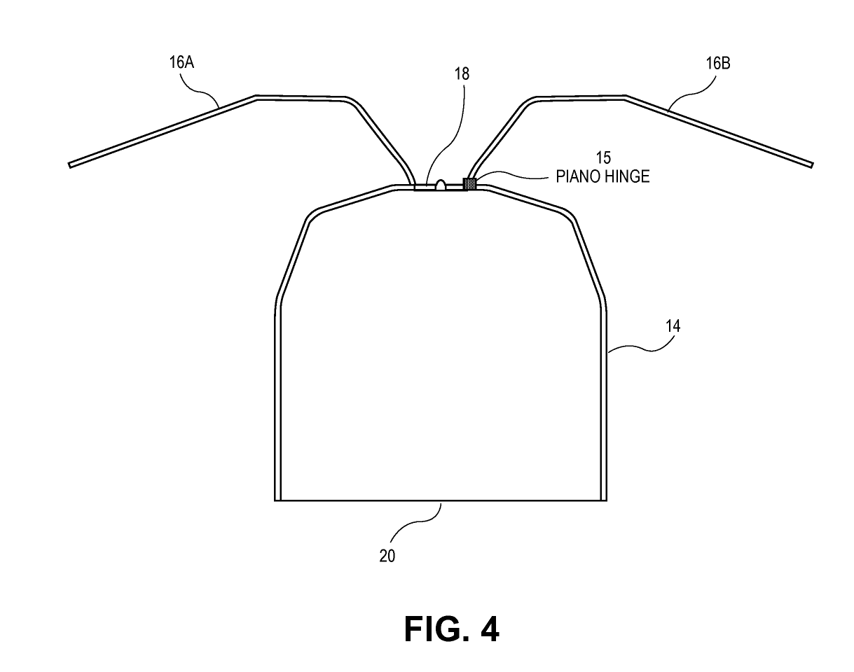

Alternatively, FIG. 4 provides a side view of the shed structure of FIG. 1 with two side doors 16A-B on two sides of the shed structure. In some embodiments, the side doors 16A-B are attached to the ridge component 18. The side doors 16A-B may be attached to the ridge component by any suitable means or elements including by hinges (e.g. piano hinges). The side doors 16A-B may rotate or pivot along a longitudinal axis 22 of the ridge component 18 (best seen in FIG. 1) to open and close. In further embodiments, the side doors 16A-B may also serve as part of the shed roof and as a side wall. As shown in FIG. 4, side door 16A includes a roof portion at the top of the shed structure and a lower portion that comprises a side wall of the shed. In some embodiments, an entire side wall may be formed from the side door. In other embodiments, the side door may constitute a section of the side wall. The remaining portion of the side wall may be constructed from panels as described above that do not rotate or move to expose the interior space of the shed structure.

FIG. 4 shows both side walls formed completely by side doors 16A-B. Side doors 16A-B cooperate with frame assembly 10 to cover or expose the opening defined by the frame assembly 10 on either side of the ridge component 18. In alternative embodiments, the base of the shed structure may include panels or flooring that are above the ground and higher than the lower frame component 20 such that the length of the side doors is less than the height of the shed. In such cases, the side doors cooperably meet with the front end frame, rear end frame, and the raised base of the shed to expose or cover the interior space of the shed structure.

In some variations, the side doors 16A-B are advantageously shaped to match the contour of the arcuate or bow shape of the front end and rear end frames. As shown in FIG. 4, the side doors 16A-B have a gull-wing shape allowing the door to open by lifting at a connection attached to the ridge component. This allows a user to access items stored at and near the sides of the shed structure.

Alternatively, the side doors may not be connected to the ridge component 18. Instead, the attachment may be along the length of the side wall such that the side door can open without necessarily lifting the roof of the shed structure. Any shaped door suitable for cooperating with the sides of the shed structure may be used.

In other embodiments, the opening and closing of the side doors are facilitated by a retaining member. For example, gas spring shocks (not shown) connected between the doors and the frame may be used to assist with opening the doors and keeping them open. In other embodiments, any suitable means such as a latch, lock, door clip, springs, hinges, etc. may be used to keep the doors open or closed.

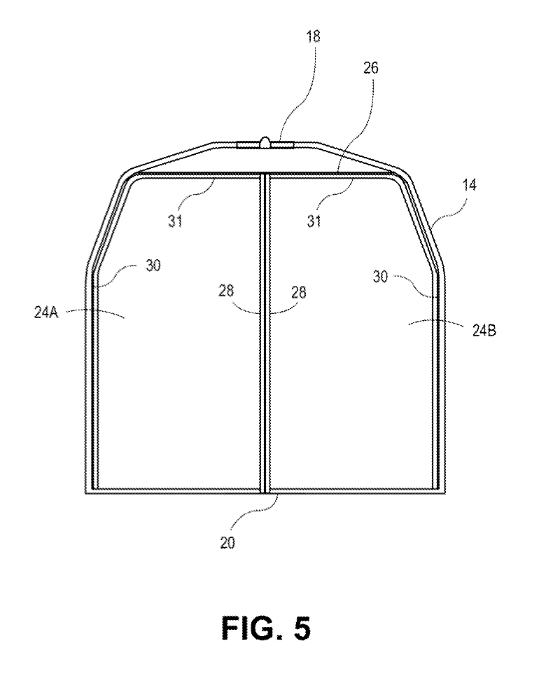

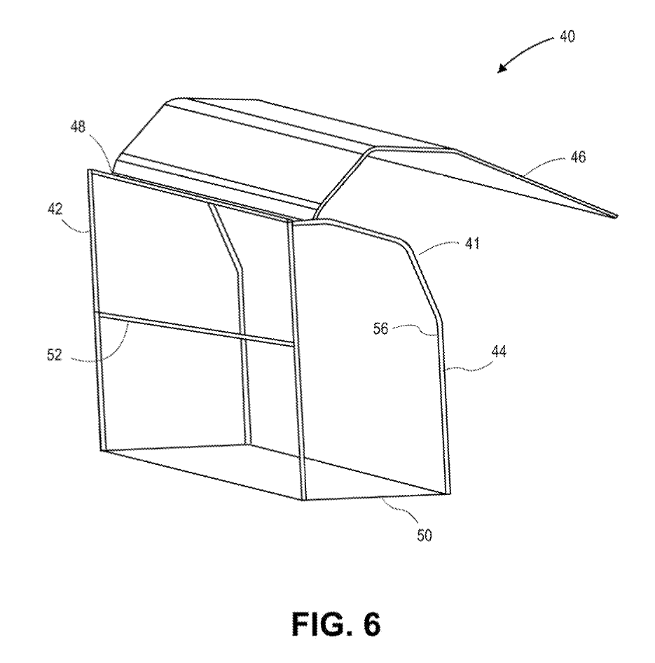

In addition to the side walls, the shed structure can include end walls at the front end and rear end. The end walls may fully cover the front or rear end. Alternatively, an end wall may be partially formed by an end door. In other embodiments, the end wall is formed by a plurality of doors. FIG. 5 shows an embodiment of the shed structure with two end doors 24A-B at front end. End doors 24A-B are attached the front end frame 14 by a door frame 26. The end doors 24A-B may be moveably attached to door frame 26 by any suitable means such as hinges allowing the end doors 24A-B to open and close. For example, the hinges may be placed at an inner edge 28 or outer edge 30 of the doors. Alternatively, the doors may be attached at a top portion of the door frame 26 by a hinge 31. In some embodiments, the rear end includes at least one door that forms the rear end wall partly or completely.

In some embodiments, as shown in FIGS. 4 and 5, the shed structure has end doors at the front end and rear end and side doors on either side. In such embodiments, all doors may be opened and closed independently of each other. Moreover, all doors may be in an open position at the same time to expose an enclosed space within the frame assembly. In further embodiments, any type of suitable door may be used. For example, a folding door, sliding door, gull-wing door, etc. may be used.

Additionally, sealing materials such as weather stripping may be used between connection points on the shed structure to seal the interior of the shed from the elements. For example, weather stripping may be used between the door and shed frame to provide a waterproof seal protecting the contents inside the shed. Weather stripping may be placed anywhere on the shed structure as needed.

In another embodiment, the shed structure may include a partially or completely open or uncovered side wall. As shown in FIG. 6, shed structure 40 has a frame assembly 41. Frame assembly 41 includes a front end frame 44, a rear end frame 42, a ridge component 48, and a lower bottom frame 50. The frame assembly 41 also includes a longitudinal bar or member 52 connecting a section of the front end frame 44 with a section of the rear end frame 42. FIG. 6 shows shed 40 with a front end defined by the front end frame 44 and the lower bottom frame 50 and a rear end defined by the rear end frame 42 and the lower bottom frame 50. The shed structure 40 also includes a covered side defined by one side of the ridge component 48 and the end and bottom frames (42, 44). The covered side includes a gull-wing door 46 moveably attached to the ridge component 48. Additionally, the shed 40 includes an uncovered side defined by the other side of the ridge component 48, end frames (42, 44), and bottom frame 50. The uncovered side also includes a longitudinal member 52 that crosses the uncovered space and intersects vertical members of the front and end frames. In some embodiments, a plurality of longitudinal members may connect the front and end frames. In other embodiments, the uncovered space does not have a longitudinal member.

In further variations, the uncovered side may be placed against a fence or building to provide a wall against the uncovered side. In other embodiments, the uncovered side may be partially covered and partially uncovered. In further embodiments, the uncovered side may be coverable by a removable panel or sheets.

Shed 40 may include end door(s) 56 and a side door 46 that can all be in the open position at the same time. In some cases, the shed 40 may include a set of doors that allow a motorcycle to be ridden into the shed from one end while the rider may exit from the side door 46 of the shed. Any acceptable hinges or attachment elements (as described above) may be used to connect the door(s) to the shed structure. In some embodiments, the doors lift upwards to expose the interior of the shed. In other embodiments, the doors open and close by pivoting along a vertical axis of the frame assembly.

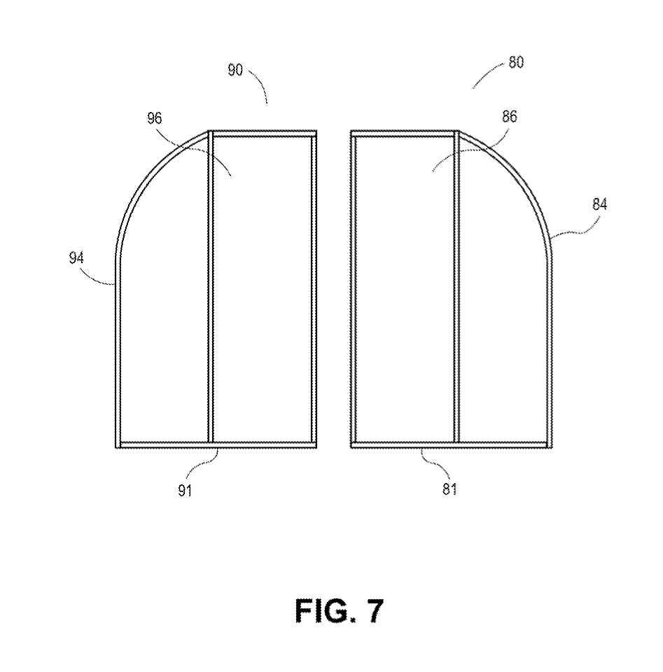

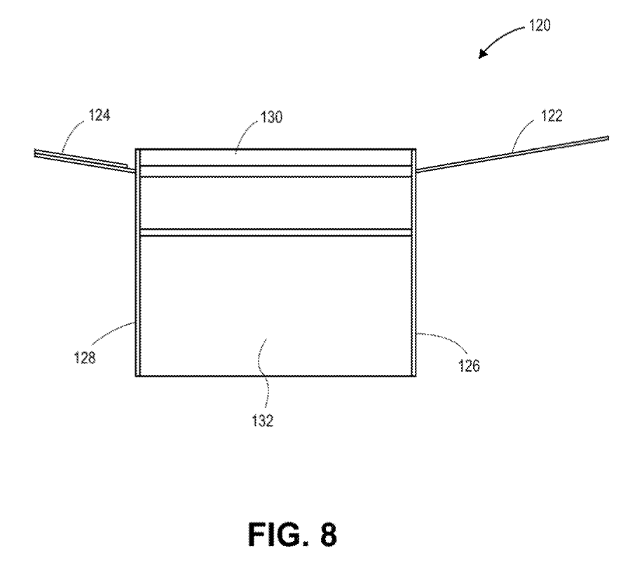

In an alternative embodiment, the shed structure may include modular units that can be used alone or in conjunction for storage. FIG. 7 shows two modular units 90 and 80. Each unit includes a frame assembly for an open uncovered side as described above. The frame assembly of each unit 90 and 80 may have respective front end frames 94, 84, rear end frames, lower bottom frames 91, 81, etc. Each modular unit may also have respective doors 96 and 86. Two modular units can be connected by facing the uncovered sides toward each other. The two units are connected by locking or latching the units together. In some embodiments, only one of the modular units may have an end door or a side door. In other embodiments, the modular units have a plurality of doors that can include multiple end doors, side doors, or any combination thereof. In some variations, the shed has a height of 75.137 inches and a width of about 47.875 inches. FIG. 8 shows an alternative embodiment where one of the end doors 124 is foldable. End door 122 is not foldable. Ridge component 130 connects ends frames 128 and 126. Side door 132 provides a side wall for the shed 120.

As described, the shed structures discussed can also function as a greenhouse. By providing translucent, transparent, or light transmitting material for the doors or the walls, the shed structure can be constructed to transmit and retain heat within the interior. Any acceptable material may be used such as translucent panels, glass, sheeting, glazing, polycarbonate coverings, etc.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1. An easy access shed structure comprising:
a frame assembly having a lower bottom frame defining a bottom of the shed structure, the lower bottom frame connected to a front end frame along a perimeter, wherein the front end frame defines a front end of the shed structure; a rear end frame connected to another perimeter of the lower bottom frame, wherein the rear end frame defines a rear end of the shed structure; and a ridge component positioned on a top portion of the shed structure, the ridge component connected to the front end and rear end frames;
a front door attached to the front end frame and cooperable with the front end frame and lower bottom frame to provide a front wall;
a rear door attached to the rear end frame and cooperable with the rear end frame and lower bottom frame to provide a rear wall;
a first side door attached to the ridge component, the first side door providing a side wall of the shed structure; and
a second side door attached to the ridge component, the second side door providing a side wall of the shed structure, wherein the side doors, in a closed position, extend from the ridge component to the bottom of the shed and cooperably meet with the frame assembly, and are configured to move outward from a longitudinal axis of the ridge component to expose an enclosed space within the frame assembly.

2. The easy access shed structure of claim 1, wherein the front and rear end frames comprise an arcuate or bowed shape.

3. The easy access shed structure of claim 1, wherein the side doors, the front door, and the rear door can all be in an open position at the same time to expose an enclosed space within the frame assembly.

4. The easy access shed structure of claim 1 further comprising an attachment element configured to moveably attach the first side door to the ridge component.

5. The easy access shed structure of claim 4, wherein the attachment element comprises a piano hinge.

6. The easy access shed structure of claim 1, wherein the first side door comprises a locking mechanism connected to the first side door to retain the first side door in an open orientation.

7. The easy access shed structure of claim 1, wherein the locking mechanism is a gas spring.

8. The easy access shed of claim 1 further comprising weather stripping, wherein the stripping is placed at points of connection between a door and the frame assembly, the weather stripping providing a seal against water.

9. The easy access shed structure of claim 1 wherein at least one of the doors comprises material allowing the transmission of light and infrared radiation into the enclosed space of the shed structure.

10. The easy access shed structure of claim 1 wherein the shed structure is a greenhouse.

11. The easy access shed structure of claim 1, wherein at least one of the doors or walls comprises a translucent heat-retaining material.

12. The easy access shed structure of claim 1, wherein at least one of the doors is foldable.

13. The easy access shed structure of claim 1, wherein the side doors pivot relative to the ridge component.

14. The easy access shed structure of claim 1, wherein the side doors have an arcuate shape.

15. An easy access shed structure comprising
a frame assembly having a lower bottom frame defining a floor of the shed structure, the lower bottom frame connected to a front end frame along a perimeter, wherein the front end frame defines a front end of the shed structure; a rear end frame connected to another perimeter of the lower bottom frame, wherein the rear end frame defines a rear end of the shed structure; a ridge component positioned on a top portion of the shed structure, the ridge component connected to the front end and rear end frames; and a longitudinal member intersecting a vertical member of the front end frame and a vertical member of the rear end frame;
a front door attached to the front end frame and cooperable with the front end frame and lower bottom frame to provide a front wall;
a rear door attached to the rear end frame and cooperable with the rear end frame and lower bottom frame to provide a rear wall;
a side door attached to the ridge component, the side door providing a side wall of the shed structure, wherein, in a closed position, the side wall extends from the ridge component to the floor of the shed and cooperably meets with the frame assembly; and
an uncovered section of the shed structure defined by a portion of the front, rear, and lower bottom frames and the ridge component, wherein the longitudinal member traverses the uncovered section by intersecting the vertical members of the end frames.

16. The easy access shed structure of claim 15, further comprising a second side wall enclosing a space within the shed structure.

17. The easy access shed structure of claim 15, wherein the second side wall is a door.

18. A shed structure comprising:
a plurality of modular units having a frame assembly having a lower bottom frame defining a floor of the shed structure, the lower bottom frame connected to a front end frame along a perimeter, wherein the front end frame defines a front end of the shed structure; a rear end frame connected to another perimeter of the lower bottom frame, wherein the rear end frame defines a rear end of the shed structure; a ridge component positioned on a top portion of the shed structure, the ridge component connected to the front end and rear end frames; and a longitudinal member intersecting a vertical member of the front end frame and a vertical member of the rear end frame;
a front door attached to the front end frame and cooperable with the front end frame and lower bottom frame to provide a front wall;
a rear door attached to the rear end frame and cooperable with the rear end frame and lower bottom frame to provide a rear wall;
a side door attached to the ridge component, the side door providing a side of the shed with a side wall door, wherein, in a closed position, the side wall door extends from the ridge component to the floor of the shed and cooperably meets with the frame assembly, and wherein the side wall door is configured to move outward from the ridge component to expose an enclosed space within the frame assembly; and
an uncovered second side opposite the side wall door;
wherein each modular unit is configured to be joined to another modular unit at the second side.

19. (canceled)

20. The shed structure of claim 18, further comprising a material capable of retaining thermal energy within the enclosed space of the shed structure.

21. The shed structure of claim 1, wherein the bottom of the shed structure is open.

22. The shed structure of claim 1, wherein the bottom of the shed structure comprises at least one panel separating the enclosed space from ground.
